(19) United States
(12) Patent Application Publication
(10) Pub. No.: US 2008/0249678 A1
(43) Pub. Date: Oct. 9, 2008

(54) Aircraft Failure Diagnostic Method and System

(75) Inventors: Carine Bailly, Tournefeuille (FR); Christian Albouy, Villemur-Sur-Tarn (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/066,529

(22) PCT Filed: Sep. 19, 2006
(86) PCT No.: PCT/EP2006/066506

§ 371 Date: Jun. 6, 2008

(30) Foreign Application Priority Data
Sep. 23, 2005 (FR) 05 09778

(51) Int. Cl. G01M 17/007; G06F 17/30

(52) U.S. Cl. 701/29

(57) ABSTRACT

The present invention relates to an aircraft failure diagnostic method and system. The method includes one configuration phase defining the possible correlations between the detectable faults. Each of these correlations are associated with data pertinently describing the circumstances of the malfunction and appropriate failure-repair operations. A phase of correlating the detected fault is performed phase of recovering the data describing the circumstances of the malfunction and a phase of determining failure-repair operations is then performed.

### CROSS-REFERENCE TO RELATED APPLICATIONS

The present Application is based on International Application No. PCT/EP2006/066506, filed on Sep. 19, 2006, which in turn corresponds to French Application No. 05 09778, filed on Sep. 23, 2005, and priority is hereby claimed under 35 USC §119 based on these applications. Each of these applications are hereby incorporated by reference in their entirety into the present application.

### FIELD OF THE INVENTION

The present invention relates to an aircraft failure diagnostic method and system. It applies notably in the field of avionics.

### BACKGROUND OF THE INVENTION

Aircraft maintenance is a continuous process which is not limited to a few periodic inspections for complete checking. Throughout the operation of a craft, the latter is monitored constantly. Initially the flight engineers receive, in flight, alarms that they analyze instantaneously and that they report in the logbook of the aircraft. Subsequently the maintenance technicians on the ground collect after each flight the failure or malfunction data generated during the flight. These data have been generated either in an automatic manner by avionics equipment or in a manual manner by the flight personnel.

After each landing and before any new takeoff, even in the case of a simple stopover, the aircraft undergoes an airport maintenance intervention. All the traces of events characterizing a failure or abnormal operation of one of the items of equipment of the aircraft during the last flight are recovered, analyzed and interpreted with a view to establishing a diagnostic as regards the ability of the aircraft to take off and to fly again under satisfactory safety conditions. To establish this diagnostic, the operator has available several sources of information on failures, these sources being heterogeneous in nature. First of all he peruses the logbook drawn up by the pilot that summarizes in particular all the events that are related to a malfunction and have had a cockpit effect, that is to say which gave rise to an alarm, be it audible or visual, for the benefit of the flight deck. Certain malfunctions are considered to be superficial since they have no impact on safety, and consequently they do not form the subject of an alarm to the pilot. The logbook is therefore incomplete from the point of view of failures. Thereafter the operator peruses a report commonly called a “Post Flight Report” (that will be referred to as a PFR subsequently) which produces an overview of the failure messages or abnormal-operation messages issued by avionics equipment. The PFR is generated automatically by a dedicated hardware and software module called the “Centralized Maintenance System” (that will be referred to as the CMS subsequently). The maintenance operator can edit on the screen or print the PFR according to his requirements, this is a text document readable by a person skilled in the art having sufficient knowledge of maintenance operations and furnished with the maintenance guide of the craft. The PFR incriminates items of equipment called “Line Replaceable Units” (that will be referred to as LRUs subsequently) which can be hardware and software modules in racks of computer type or sensors or else actuators, that the operator can readily change if necessary. These LRUs comprise a maintenance function of a type known as “Built-In Test Equipment” (that will be referred to as a BITE function subsequently). This BITE function allows the LRUs to make copies of memory segments, to carry out diagnostics on their internal operating state and to issue reports that by extension are referred to as BITE messages. These messages contain inter alia the identifier of the incriminated LRU, a failure code and a time the fault occured. It is these BITE messages which have been sent by the LRUs to the CMS, the CMS having stored them and used them to generate the PFR. The PFR often incriminates a large number of LRUs, but often all the LRUs incriminated are not defective. Specifically there are “cascaded” LRU failures or malfunctions where it is the abnormal behavior of a single LRU which causes abnormal messages on the part of other LRUs operating normally, the latter generating the same messages as the defective LRU for example. And it is precisely here that the essence of the problem arises, since if the operator follows the content of the PFR to the letter, he will send correctly operating non-faulty equipment for repair.

A solution customarily implemented with a view to isolating the origin of the failure and to establishing a more precise diagnostic is purely manual. It involves the maintenance operator conducting successive tests and recovering the results and the copies of memory segments which will confirm or deny the incrimination of each LRU in the PFR. First of all to determine the LRUs to be tested initially, the operator tries to imagine the cockpit effects of the malfunction of each LRU incriminated in the PFR. If this effect is entered at the same time in the logbook as the fault of the LRU in the PFR, then he starts the test procedure tied to this LRU. The operator relies entirely on the maintenance guide of the craft to accomplish this procedure and especially to determine the chaining together of the LRU test steps as a function of the results obtained. This guide shows him, step by step, the tests to be conducted. Thus, on the basis of the PFR generated by the CMS, the cockpit effects reported by the pilot in the logbook and the maintenance guide of the craft, the operator should end up with a restricted list of LRUs in an actual state of failure or malfunction. As a function of the status of each of these LRUs in regard to flight safety, status commonly expressed by the terms “GO” or “NO GO”, as a function of the recommendations of the maintenance guide and also of the experience of the operator, the latter undertakes the replacement of the LRUs before the aircraft takes off again. In certain cases this can lead to the grounding of the craft, notably on account of replacement LRU unavailability or on recommendation of the maintenance guide.

A first major drawback of this solution is the delay necessary for its execution. Specifically the PFR is an exhaustive and on-the-spot report, its comprehension is not obvious. The logbook that must be matched up with the PFR is not only incomplete, but is also neither dedicated nor even geared to maintenance and therefore requires a certain time in order to be interpreted correctly. And finally the maintenance guide represents a very significant amount of information that it is difficult to manipulate. Moreover, each test step and the recovery of the memory segment copies often require several minutes. Now, the context of economic profitability in which these operations are implemented must be taken into account. For example, stopovers must not exceed a certain duration in order to achieve the greatest profitability of the craft and airport facilities. Consequently in numerous cases, the operator will prefer to change LRUs if he does not have time to finish the tests and the repair services then receive non-faulty LRUs. Thus this solution presents major economic drawbacks, whether it is from the point of view of the airline that owns the aircraft or from the point of view of the company operating the airport or else from the point of view of the firm providing the equipment maintenance services in workshop.

Another major drawback of this solution is that the share of assessment left to the operator in this context of economic pressure is a source of potential error which implies that there is a risk of aircraft going out again with defective LRUS. Thus this solution also presents a drawback from the point of view of the safety of travellers.

One of the main reasons why the diagnostic of the failures is abandoned to the variable expertise of maintenance operators is the unavailability of pertinent relations between the potential symptoms of fault during the design of the craft. Specifically these relations are known only as and when it is operated, but it is then too late and above all too expensive to envisage updating the avionics maintenance functions.

An aim of the invention is notably, by relying on a thorough knowledge of the avionics system and on all the experience amassed in the maintenance of the craft in question, to indicate to the ground maintenance operator failure-repair operations relevant to the malfunctions detected. For this purpose, the subject of the invention is an aircraft failure diagnostic method and system. The method comprises at least one configuration phase defining the possible correlations between the detectable faults, associating, with each of these correlations, data pertinently describing the circumstances of the malfunction and appropriate failure-repair operations. It also comprises at least one phase of correlating the detected faults, a phase of recovering the data describing the circumstances of the malfunction and a phase of determining failure-repair operations.

Advantageously the relations defined during the configuration phase can be modeled in the form of a matrix with i rows and (m+n+p) columns, where i, m, n and p are nonzero integers, i is the number of distinct fault correlations, m is the maximum number of faults which can be correlated, n is the maximum number of data which pertinently describe the circumstances of a malfunction and which can be recovered and p is the maximum number of failure-repair operations which can be indicated.

For example the detectable faults include BITE maintenance messages issued by avionics equipment or alarm messages sent to the pilot.

### SUMMARY OF THE INVENTION

The main advantages of the invention are moreover that it makes it much simpler to utilize the maintenance data since it produces a final overview, which can be included in the PFR for example. If it is implemented in flight, the invention allows the maintenance operator to peruse this overview before landing remotely and he can therefore best prepare his intervention, by obtaining in advance the LRUs that have supposedly failed in the PFR for example. The invention is adaptable to the degree of expertise of each airport by updating the configuration data, possibly remotely, by tailoring the level of detail of the PFR for example. It permits effective amassing of the experience of maintenance operators by updating the configuration data on experiential feedback. Put in place well before the aircraft is put into service but configurable even well after, it will not necessitate any software update when the pertinence of the various correlations is established. Thus, in the trial phase, these correlations between failure data, even if they require refinements, may already be a valuable tuning tool.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, schematically, the successive phases of the method according to the invention;

FIG. 2, by a diagram an exemplary hardware and software architecture implementing a system according to the invention.

### DETAILED DESCRIPTION OF THE DRAWINGS

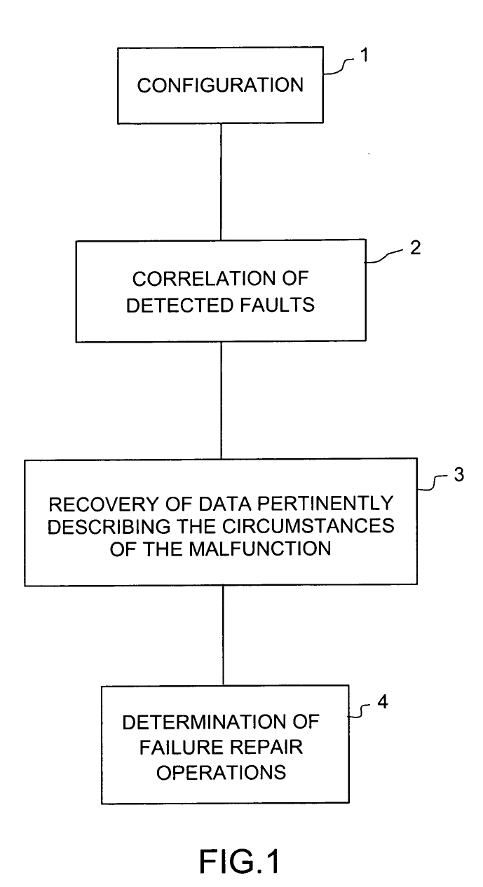

FIG. 1 illustrates schematically the phases of the method according to the invention.

It comprises first of all a configuration phase 1. This phase is a phase of defining the data used by the method which depend on the avionics system. It is carried out initially before utilizing the avionics system, before a failure or a malfunction can come about. First of all it allows possible relationships to be defined between the various events characteristic of poor operation and which might occur during a flight. For example these relationships may convey cause and effect relations deduced from a thorough knowledge of the architecture of the avionics system concerned. This phase also makes it possible to define data pertinently describing the circumstances of a malfunction, such as for example the temperature of certain items of equipment, their wiring state or the state of the items of equipment paired with them, or else the speed and the pressure, as well as the detailed mode of recovery of these data. The latter are associated with each group of related events. Finally this phase 1 makes it possible to define ground failure-repair operations and to associate them here again with each group of related events. All these associations will be useful in the subsequent phases of the method that are described in what follows. They are stored for this purpose.

Then a phase 2 of correlating the faults is triggered after the occurrence of an event characteristic of poor operation. It is therefore very probable that this phase will be executed several times per flight. The possible correlations have been defined during the configuration phase as possible relationships between the events, cause and effect relationships for example. It should be noted that it is not always possible to carry out a correlation of events, either because no other event arises, or because the events arisen do not form the subject of a relationship defined during the configuration phase. In this case the event is considered to be isolated but this does not prevent its processing in the following phases. At the end of this phase, the isolated event or the related events are stored for the benefit of a maintenance operator.

The result of the phase of correlating the faults is used immediately by a phase 3 of recovering the data pertinently describing the circumstances of the malfunction. In what follows, these data will be referred to as the context data. As a function of the isolated event or of the group of related events and of the context data which were associated therewith during the configuration phase, certain very particular items of equipment are interrogated regarding their state at the time the malfunction was detected. All the data necessary for this targeted interrogation were defined during the configuration phase. This phase terminates on receipt of the responses returned by the items of equipment, which responses are stored for the benefit of a maintenance operator. An essential point of the invention is the consideration of these context data regarding any item of equipment that might be connected with the fault with a view to establishing the most pertinent possible failure diagnostic.

Finally a phase 4 of determining failure-repair operations makes it possible to indicate immediately ground failure-repair operations that are appropriate as a function of the isolated event or of the group of related events which have arisen and of the context data at that time, still on the basis of the associations defined during the configuration phase. This indication of failure-repair operations is stored for the benefit of the ground maintenance operator, who will change the incriminated equipment. Possibly, no indication is given through lack of experience in regard to certain types of fault. And it is precisely the knowledge acquired while utilizing the method that will enable the latter to be supplemented by virtue of the experiential feedback of the maintenance operators. This is an essential advantage of the invention.

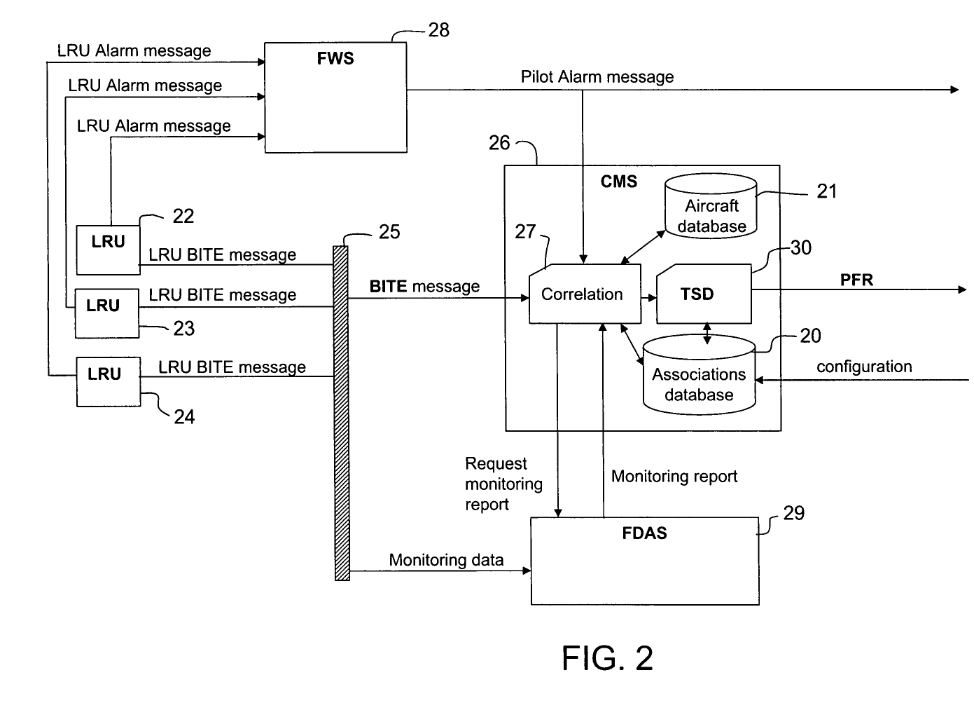

FIG. 2 illustrates through a diagram an exemplary hardware and software architecture implementing a system according to the invention. In this mode of realization a database 20 called the associations database advantageously stores a configuration matrix. A database 21 called the aircraft database stores notably a modeling of the hardware and software architecture of the avionics equipment of the craft, the data of this modeling having been provided during the configuration phase of the method according to the invention. The configuration matrix contains the possible relations between the various events characteristic of poor operation, the associated context data and the appropriate ground failure-repair operations. For example it is a matrix with i rows and (m+n+p) columns with i, m, n and p nonzero positive integers. The i rows make it possible to represent the i relations, known at the time the system is implemented, between events characteristic of malfunction. The first m columns make it possible to associate a maximum of m events characteristic of malfunction, the following n columns make it possible to associate with them a maximum of n context data and the last p columns make it possible finally to associate with them a maximum of p failure-repair operations. The associations database stores this configuration matrix in a phase of initializing the avionics system, before each takeoff for example, so as to best adapt the system to the level of expertise of the next airport at which the aircraft will land and where the failure-repair operations will be performed. The aircraft database stores the details of the context data recovery mode, for example the address of the items of equipment on the data bus 25, with a view to sending to these items of equipment requests relating to their state should a malfunction be detected. This database is filled once and for all when installing the avionics equipment in the aircraft. It may possibly be updated should the avionics system be modified in the course of the life of the craft. The two databases form part of a sub-system 26 of CMS type intended, as explained previously, to provide PFRs. In the example illustrated by the figure, the configuration data are stored in databases, but they can even so be copied across to the random access memory of a computer of the CMS during their use, to improve the data access times.

In this example, the avionics items of equipment capable of providing failure or malfunction messages are the three LRUs 22, 23 and 24. These LRUs comprise for example a BITE function described previously which allows the LRUs to carry out diagnostics on their internal operating state and to issue BITE messages containing, inter alia, an incriminated LRU identifier, a failure code and a time the fault occured. In the example of the figure, the LRUs are connected to the same data bus 25 to which the CMS 26 is also connected. On receipt by the CMS of a BITE message issued by one of the LRUs, the phase of correlating the faults of the method according to the invention is triggered by activating a correlation function 27. In this example the correlation function advantageously tries to establish relations between the BITE messages received and the alarm messages sent to the flight deck by utilizing the first m columns of the configuration matrix. Specifically the correlation function also listens out for the outputs of a sub-system 28 called the “Failure Warning System” (that will be referred to as the FWS subsequently), the function of which is to filter alarm messages issued by the LRUs and to produce an overview thereof that can be utilized by the pilot as a function of their pertinence in regard to the safety conditions. It is possible to envisage a mode of realization of the correlation function where the BITE messages are not inter-associated and where each BITE message is associated in an independent manner with cockpit alarm messages. It is also possible to envisage a mode of realization of this function where the BITE messages are at one and the same time inter-associated and at the same time associated with cockpit alarm messages. Once a relation between the BITE messages and the alarms has been established in accordance with the first m columns of a row j of the configuration matrix, the correlation function supplements this relation with so-called monitoring data which are in fact the malfunction context data, such as the temperature of an item of equipment or its wiring state or else the state of its paired item of equipment. This is the phase of recovering the data pertinently describing the circumstances of the malfunction of the method according to the invention. For this purpose, the correlation function utilizes the following n columns of row j of the configuration matrix. It also uses the details of the modes of interrogating the items of equipment described in the aircraft database, such as their address on the data bus, so as to send monitoring report requests targeting each of the potentially incriminated items of equipment. These requests are processed by a centralizer sub-system 29 called the “Flight Data Acquisition System” (that will be referred to as the FDAS subsequently) which returns a monitoring report in response to the correlation function. This sub-system is knowledgeable in regard to all the monitoring data, for example by virtue of a direct connection to the data bus, which is itself fed with monitoring data by mechanisms that are known elsewhere.

Finally the function 30 called the “Trouble Shooting Data” (that will be referred to as the TSD function subsequently) utilizes the last p columns corresponding to row j of the configuration matrix to deduce appropriate failure-repair operations. It provides the final result of the method in the form of a PFR in this mode of realization. The PFR produces notably an overview of all the associations effected between BITE messages, alarm messages and monitoring data. For each of these associations, the PFR indicates, above all, appropriate failure-repair operations. It should be noted that the indications of failure-repair operations arising from the last p columns of row j of the configuration matrix are deduced not only from a thorough knowledge of the architecture of the system, but that they also take account of the monitoring data which are data targeted on items of equipment at the very moment of the fault. The consideration of these monitoring data to establish a diagnostic and to indicate appropriate failure-repair operations is an essential point of the invention.

If the correlation function and the TSD function are executed during the flight, it merely remains for the ground maintenance operator after landing to consult the PFR so as possibly to ascertain which LRUs to replace. It may even be envisaged that the PFR be issued to the ground and that the operator peruse it before the landing. Thus he can obtain the failed LRUs before joining the aircraft on the tarmac.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. An aircraft failure diagnostic method,
one configuration phase defining the possible correlations between the detectable faults, associating, with each of these correlations, data pertinently describing the circumstances of the malfunction and appropriate failure-repair operations, the relations thus defined being modeled in the form of a matrix with i rows and (m+n+p) columns, where i, m, n and p are nonzero integers, i being the number of distinct fault correlations, m being the maximum number of faults which can be correlated, n being the maximum number of data which pertinently describe the circumstances of a malfunction and which can be recovered and p being the maximum number of failure-repair operations which can be indicated;
one phase of correlating the detected faults;
one phase of recovering the data describing the circumstances of the malfunction; and
one phase of determining failure-repair operations.

2. The aircraft failure diagnostic method as claimed in claim 1, wherein the detectable faults include BITE maintenance messages issued by avionics equipment.

3. The aircraft failure diagnostic method as claimed in claim 1 wherein the detectable faults include alarm messages sent to the pilot.

4. An aircraft failure diagnostic system, comprising:
an apparatus for storing data defining the possible correlations between the detectable faults, associating, with each of these correlations, data pertinently describing the circumstances of the malfunction and appropriate failure-repair operations, in the form of a matrix with i rows and (m+n+p) columns, where i, m, n and p are nonzero integers, i being the number of distinct fault correlations, m being the maximum number of faults which can be correlated, n being the maximum number of data which pertinently describe the circumstances of a malfunction and which can be recovered and p being the maximum number of failure-repair operations which can be indicated;
a module for correlating the detected faults;
a module for recovering the data describing the circumstances of the malfunction;
a module for determining failure-repair operations.
